(19) United States
(12) Patent Application Publication
(10) Pub. No.: US 2019/0339887 A1
(43) Pub. Date: Nov. 7, 2019

(54) METHOD, APPARATUS AND COMPUTER PROGRAM PRODUCT FOR MANAGING DATA STORAGE

(71) Applicant: EMC IP Holding Company LLC, Hopkinton, MA (US)

(72) Inventors: Nickolay A. Dalmatov, Saint Petersburg (RU); Michael Patrick Wahl, Bulverde, TX (US); Jian Gao, Beijing (CN)

(21) Appl. No.: 15/968,930

(22) Filed: May 2, 2018

(51) Int. Cl. G06F 3/06

(52) U.S. Cl. CPC G06F 3/0632; G06F 3/0689; G06F 3/0604

(57) ABSTRACT

There is disclosed herein techniques for use in managing data storage. In one embodiment, the techniques comprise defining, for each of a plurality of data storage drives, one or more areas on a data storage drive such that each area on the data storage drive corresponds to an area associated with similar I/O characteristics on the other data storage drives. The techniques also comprise selecting two or more drive extents from corresponding areas on different data storage drives of the plurality of data storage drives. The techniques further comprise forming a RAID extent based on the selected drive extents.

### TECHNICAL FIELD

The present invention relates generally to data storage. More particularly, the present invention relates to a method, an apparatus and a computer program product for managing data storage.

### BACKGROUND OF THE INVENTION

Systems may include different resources used by one or more host processors. Resources and host processors in the system may be interconnected by one or more communication connections, such as network connections. These resources may include, for example, data storage devices such as those included in the data storage systems manufactured by Dell EMC. These data storage systems may be coupled to one or more host processors and provide storage services to each host processor. Multiple data storage systems from one or more different vendors may be connected and may provide common data storage for one or more host processors in a computer system.

A host may perform a variety of data processing tasks and operations using the data storage system. For example, a host may perform basic system I/O (input/output) operations in connection with data requests, such as data read and write operations.

Host systems may store and retrieve data using a data storage system containing a plurality of host interface units, disk drives (or more generally storage devices), and disk interface units. Such data storage systems are provided, for example, by Dell EMC of Hopkinton, Mass. The host systems access the storage devices through a plurality of channels provided therewith. Host systems provide data and access control information through the channels to a storage device of the data storage system and data of the storage device is also provided from the data storage system to the host systems also through the channels. The host systems do not address the disk drives of the data storage system directly, but rather, access what appears to the host systems as a plurality of files, objects, logical units, logical devices or logical volumes. These may or may not correspond to the actual physical drives. Allowing multiple host systems to access the single data storage system allows the host systems to share data stored therein.

Generally, with the increasing amounts of information being stored, it may be beneficial to efficiently store and manage that information. While there may be numerous techniques for storing and managing information, each technique may have tradeoffs between reliability and efficiency.

### SUMMARY OF THE INVENTION

There is disclosed a method, comprising: defining, for each of a plurality of data storage drives, one or more areas on a data storage drive such that each area on the data storage drive corresponds to an area associated with similar I/O characteristics on the other data storage drives; selecting two or more drive extents from corresponding areas on different data storage drives of the plurality of data storage drives; and forming a RAID extent based on the selected drive extents.

There is also disclosed an apparatus, comprising: memory; and processing circuitry coupled to the memory, the memory storing instructions which, when executed by the processing circuitry, cause the processing circuitry to: define, for each of a plurality of data storage drives, one or more areas on a data storage drive such that each area on the data storage drive corresponds to an area associated with similar I/O characteristics on the other data storage drives; select two or more drive extents from corresponding areas on different data storage drives of the plurality of data storage drives; and form a RAID extent based on the selected drive extents.

There is also disclosed a computer program product having a non-transitory computer readable medium which stores a set of instructions, the set of instructions, when carried out by processing circuitry, causing the processing circuitry to perform a method of: defining, for each of a plurality of data storage drives, one or more areas on a data storage drive such that each area on the data storage drive corresponds to an area associated with similar I/O characteristics on the other data storage drives; selecting two or more drive extents from corresponding areas on different data storage drives of the plurality of data storage drives; and forming a RAID extent based on the selected drive extents.

### BRIEF DESCRIPTION OF THE DRAWINGS

The invention will be more clearly understood from the following description of preferred embodiments thereof, which are given by way of examples only, with reference to the accompanying drawings, in which:

FIG. 1 is a block diagram showing an operational environment for the disclosed technology, including an example of a data storage system in which the disclosed technology may be embodied in accordance with techniques herein;

FIG. 2 is a block diagram showing an example of a partnership group of data storage drives, a RAID extent group of RAID extent entries, and a rotation group of RAID extent entries within the RAID extent group in accordance with techniques herein;

FIG. 3 is an example illustrating areas of a data storage drive in accordance with techniques herein;

FIG. 4 is a flowchart of processing steps that may be performed in an embodiment in accordance with techniques herein.

### DETAILED DESCRIPTION

Embodiments of the invention will now be described. It should be understood that the embodiments described below are provided only as examples, in order to illustrate various features and principles of the invention, and that the invention is broader than the specific embodiments described below.

Data storage systems balance I/O (Input/Output) operations across its data storage drives in order to maximize performance. Traditionally, data storage systems maximized performance by moving logical space units (e.g., slices) between RAID (redundant array of independent disks) groups based on a number of I/O provided by the RAID groups. It should be understood that the number of I/O associated with each RAID group in a data storage system may differ due to the performance characteristics of its drives and the RAID level such that movement of slices to RAID groups associated with higher I/O may help increase performance of the data storage system. The data storage systems would have been able to use this information (i.e., the numbers for every RAID group) and the I/O level corresponding to every slice to move slices to the most appropriate RAID group.

Mapped RAID is a new approach for information protection, which is more flexible and provide better performance and economic characteristics than a legacy RAID. It should be understood that Mapped RAID splits drives in a partnership group into a set of drive extents (DE's). A number of the drive extents from different physical drives are then combined into RAID extents in accordance to the RAID level. For example, 5 DE's may be combined to create a 4+1 RAID extent. The RAID extents are then combined to create a rotation group formed from RAID extents situated on the different physical drives. For example, if the partnership group includes 15 HDD's and the type of RAID is 4+1, a rotation group will include 3 RAID extents. The reason to introduce the group is that an object situated within a group can be accessed using all or most of the physical drives in parallel. A slice is situated with a rotation group completely. The groups are then combined into RAID groups. There can be a number of RAID groups produced by a single set of physical drives forming the partnership group.

As will be understood from the foregoing, in Mapped RAID, all data storage drives (e.g., HDD's) may be part of a single pool, whereby RAID groups created on top of it are situated on the same physical drives and a single slice can span all the drives (and even multiple times). However, the I/O performance of a HDD depends on which cylinders are measured. For example, the HDD I/O performance may be different depending on whether the outer or inner cylinders of the drive are used.

The prior art does not make any attempt to create RAID groups using the rotation groups from the same range of cylinders and then explicitly state its bigger or smaller I/O capabilities. Another problem is that different RAID groups created on the same disk partnership group use the same set of drives so the legacy auto-tiering and I/O balancing approach does not work directly. In the legacy world, the RAID groups are independent and their I/O capabilities are summarized and can be used in parallel (to some extent). In mapped RAID, RAID groups created on the same set of drives shares the same I/O capabilities.

The techniques described herein form RAID extents from drive extents associated with corresponding areas of different data storage drives. As discussed above, the I/O performance of an HDD depends on which cylinders is measured. The outer ones may provide a 1.5× advantage over the inner ones. Thus, RAID extents from outer cylinders of HDDs will be able to fully utilize the I/O potential of the drives. It, therefore, makes sense to create RAID extents (and rotation and RAID groups) from drive extents situated on the same cylinders to have a uniform I/O rate across the whole group. This approach, advantageously, facilitates effective utilization of the different I/O capabilities for different HDD cylinder ranges.

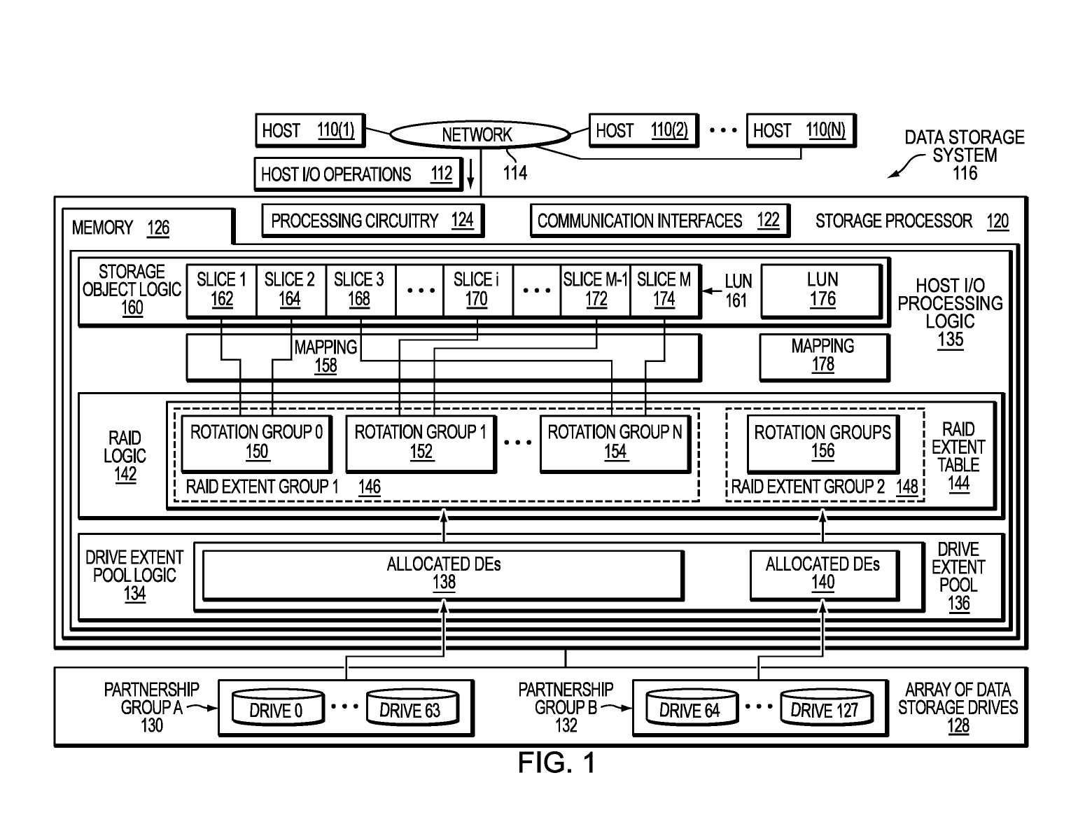

FIG. 1 is a block diagram showing an example of an operational environment for the disclosed technology, including an example of a data storage system in which the disclosed technology may be embodied. The environment of FIG. 1 includes some number of host computing devices 110, referred to as “hosts” and shown for purposes of illustration by hosts 110(1) through 110(N), that access non-volatile data storage provided by data storage system 116 using host I/O operations 112, for example over one or more computer networks, such as a local area network (LAN), and/or a wide area network (WAN) such as the Internet, etc., shown for purposes of illustration in FIG. 1 by network 114, and communicably coupled to storage processor 120 through communication interfaces 122. The data storage system 116 includes at least one storage processor 120 and an array of data storage drives 128. The storage processor 120 may, for example, be provided as a circuit board assembly, or “blade,” which plugs into a chassis that encloses and cools multiple storage processors, and that has a backplane for interconnecting storage processors. However, no particular hardware configuration is required, and storage processor 120 may be embodied as any specific type of computing device capable of processing host input/output (I/O) operations received from hosts 110 (e.g. I/O read and I/O write operations, create storage object operations, delete storage object operations, etc.).

The array of data storage drives 128 may include data storage drives such as magnetic disk drives, solid state drives, hybrid drives, and/or optical drives. The array of data storage drives 128 may be directly physically connected to and/or contained within storage processor 120, and/or may be communicably connected to storage processor 120 by way of one or more computer networks, e.g. including or consisting of a Storage Area Network (SAN) or the like.

In some embodiments, host I/O processing logic 135 (e.g. RAID logic 142 and/or drive extent pool logic 134) compares the total number of data storage drives that are contained in array of data storage drives 128 to a maximum partnership group size. In response to determining that the number of data storage drives that are contained in array of data storage drives 128 exceeds a maximum partnership group size, host I/O processing logic 135 divides the data storage drives in array of data storage drives 128 into multiple partnership groups, each one of which contains a total number of data storage drives that does not exceed the maximum partnership group size, and such that each data storage drive in the array of data storage drives 128 is contained in only one of the resulting partnership groups. In the example of FIG. 1, in which the maximum partnership group size is configured to 64, the 128 data storage drives in array of data storage drives 128 have been divided into two partnership groups, shown by partnership group A 130, which includes data storage drives 0 through 63, and partnership group B 132, which includes data storage drives 64 through 127.

In some embodiments, the maximum partnership group size may be configured to a value that is at least twice as large as the minimum number of data storage drives that is required to provide a specific level of RAID data protection. For example, the minimum number of data storage drives that is required to provide 4D+1P RAID-5 must be greater than five, e.g. six or more, and accordingly an embodiment or configuration that supports 4D+1P RAID-5 may configure the maximum partnership group size to a value that is twelve or greater. In another example, the minimum number of data storage drives that is required to provide 4D+2P RAID-6 must be greater than six, e.g. seven or more, and accordingly in an embodiment or configuration that supports 4D+2P RAID-6 the maximum partnership group size may be configured to a value that is fourteen or greater. By limiting the number of data storage drives contained in a given partnership group to a maximum partnership group size, the disclosed technology advantageously limits the risk that an additional disk will fail while a rebuild operation is being performed using data and parity information that is stored within the partnership group in response to the failure of a data storage drive contained in the partnership group, since the risk of an additional disk failing during the rebuild operation increases with the total number of data storage drives contained in the partnership group. In some embodiments, the maximum partnership group size may be a configuration parameter set equal to a highest number of data storage drives that can be organized together into a partnership group that maximizes the amount of concurrent processing that can be performed during a rebuild process resulting from a failure of one of the data storage drives contained in the partnership group.

Memory 126 in storage processor 120 stores program code that is executable on processing circuitry 124. Memory 126 may include volatile memory (e.g. RAM), and/or other types of memory. The processing circuitry 124 may, for example, include or consist of one or more microprocessors, e.g. central processing units (CPUs), multi-core processors, chips, and/or assemblies, and associated circuitry. The processing circuitry 124 and memory 126 together form control circuitry, which is configured and arranged to carry out various methods and functions as described herein. The memory 126 stores a variety of software components that may be provided in the form of executable program code. For example, as shown in FIG. 1, memory 126 may include software components such as host I/O processing logic 135. When the program code is executed by processing circuitry 124, processing circuitry 124 is caused to carry out the operations of the software components. Although certain software components are shown and described for purposes of illustration and explanation, those skilled in the art will recognize that memory 126 may include various other software components, such as an operating system, various applications, other processes, etc.

Drive extent pool logic 134 generates drive extent pool 136 by dividing each one of the data storage drives in the array of data storage drives 128 into multiple, equal size drive extents. Each drive extent consists of a physically contiguous range of non-volatile data storage that is located on a single drive. For example, drive extent pool logic 134 may divide each one of the data storage drives in the array of data storage drives 128 into multiple, equal size drive extents of physically contiguous non-volatile storage, and add an indication (e.g. a drive index and a drive extent index, etc.) of each one of the resulting drive extents to drive extent pool 136. The size of the drive extents into which the data storage drives are divided is the same for every data storage drive. Various specific fixed sizes of drive extents may be used in different embodiments. For example, in some embodiments each drive extent may have a size of 10 gigabytes. Larger or smaller drive extent sizes may be used in alternative embodiments.

RAID logic 142 generates RAID extent table 144, which contains multiple RAID extent entries. RAID logic 142 also allocates drive extents from drive extent pool 136 to specific RAID extent entries that are contained in the RAID extent table 144. For example, each row of RAID extent table 144 may consist of a RAID extent entry which may indicate multiple drive extents, and to which multiple drive extents may be allocated. Each RAID extent entry in the RAID extent table 144 indicates the same number of allocated drive extents.

Drive extents are allocated to RAID extent entries in the RAID Extent Table 144 such that no two drive extents indicated by any single RAID extent entry are located on the same data storage drive.

Each RAID extent entry in the RAID extent table 144 may represent a RAID stripe and indicates i) a first set of drive extents that are used to persistently store host data, and ii) a second set of drive extents that are used to store parity information. For example, in a 4D+1P RAID-5 configuration, each RAID extent entry in the RAID extent table 144 indicates four drive extents that are used to store host data and one drive extent that is used to store parity information. In another example, in a 4D+2P RAID-6 configuration, each RAID extent entry in the RAID extent table 144 indicates four drive extents that are used to store host data and two drive extents that are used to store parity information.

RAID logic 142 also divides the RAID extent entries in the RAID extent table 144 into multiple RAID extent groups. Accordingly, multiple RAID extent groups of RAID extent entries are contained in the RAID extent table 144. In the example of FIG. 1, RAID logic 142 divides the RAID extent entries in the RAID extent table 144 into RAID extent group 1 146 and RAID extent group 2 148. Each of the RAID extent groups in RAID extent table 144 corresponds to one of the partnership groups in the array of data storage drives 128. In the example of FIG. 1, RAID extent group 1 146 corresponds to partnership group A 130, and RAID extent group 2 148 corresponds to partnership group B 132. Drive extents from drive extent pool 136 that are located on data storage drives in partnership group A 130 are only allocated to RAID extent entries in RAID extent group 1 146, as shown by allocated drive extents 138. Drive extents from drive extent pool 136 that are located on data storage drives in partnership group B 132 are only allocated to RAID extent entries in RAID extent group 2 148, as shown by allocated drive extents 140. As a result, the RAID extent entries in each RAID extent group only indicate drive extents that are located on the data storage drives that are contained in the corresponding partnership group. Accordingly, RAID extent entries in RAID extent group 1 146 only indicate drive extents that are located on the data storage drives that are contained in partnership group A 130, and RAID extent entries in RAID extent group 2 148 only indicate drive extents that are located on the data storage drives that are contained in partnership group B 132.

The drive extent pool 136 may also include a set of unallocated drive extents located on data storage drives in partnership group A 130 and associated with RAID extent group 1 146, that may be allocated to RAID extent entries in RAID extent group 1 146 in the event of a data storage drive failure, i.e. to replace drive extents that are located on a failed data storage drive contained in partnership group A 130. Similarly, drive extent pool 136 may also include a set of unallocated drive extents located on data storage drives in partnership group B 132 and associated with RAID extent group 2 148, that may be allocated to RAID extent entries in RAID extent group 2 148 in the event of a data storage drive failure, i.e. to replace drive extents that are located on a failed data storage drive contained in partnership group B 132.

When a drive extent is allocated to a RAID extent entry, an indication of the drive extent is stored into that RAID extent entry. For example, a drive extent allocated to a RAID extent entry may be indicated within that RAID extent entry by storing a pair of indexes “m|n” into that RAID extent entry, where “m” indicates a drive index of the data storage drive on which the drive extent is located (e.g. a numeric drive number within array of data storage drives 128, a slot number within which the physical drive located, a textual drive name, etc.), and “n” indicates an index of the drive extent within the data storage drive (e.g. a numeric drive extent number, a block offset, a sector number, etc.). For example, in embodiments in which data storage drives are indexed within array of data storage drives 128 starting with 0, and in which drive extents are indexed within the data storage drive that contains them starting with 0, a first drive extent of drive 0 in array of data storage drives 128 may be represented by “010”, a second drive extent within drive 0 may be represented by “011”, and so on.

The RAID logic 142 divides the RAID extent entries in each one of the RAID extent groups into multiple rotation groups. For example, RAID logic 142 divides RAID extent group 1 146 into a set of N rotation groups made up of rotation group 0 150, rotation group 1 152, and so on through rotation group N 154. RAID logic 142 also divides RAID extent group 2 148 into rotation groups 156. Each RAID extent group may be divided into an integral number of rotation groups, such that each individual rotation group is completely contained within a single one of the RAID extent groups. Each individual RAID extent entry is contained in only one rotation group. Within a RAID extent group, each rotation group contains the same number of RAID extent entries. Accordingly, each one of the N rotation groups made up of rotation group 0 150, rotation group 1 152, through rotation group N 154 in RAID extent group 1 146 contains the same number of RAID extent entries. Similarly, each one of the rotation groups in rotation groups 156 contains the same number of RAID extent entries.

In at least one embodiment, storage object logic 160 generates at least one corresponding logical unit (LUN) for each one of the RAID extent groups in RAID extent table 144. In the example of FIG. 1, storage object logic 160 generates LUN 161 corresponding to RAID extent group 1 146, and LUN 176 corresponding to RAID extent group 2 148. While for purposes of concise illustration FIG. 1 shows only one LUN generated per RAID extent group, the technology disclosed herein is not limited to such embodiments or configurations, and alternatively multiple LUNs may be generated for each RAID extent group.

Each one of the LUNs generated by storage object logic 160 is made up of multiple, equal sized slices. Each slice in a LUN represents an addressable portion of the LUN, through which non-volatile storage indicated by RAID extent entries in the corresponding RAID extent group is accessed. For example, each slice of a LUN may represent some predetermined amount of the LUN's logical address space. For example, each slice may span some predetermined amount of the LUN's logical address space, e.g. 256 megabytes, 512 megabytes, one gigabyte, or some other specific amount of the LUN's logical address space.

For example, as shown in FIG. 1, LUN 161 may be made up of M equal sized slices, shown for purposes of illustration including slice 1 162, slice 2 164, slice 3 168, and so on through slice i 170, and so on through slice M 174. For example, where a logical block address space of LUN 161 contains logical blocks numbered from 1 to x, slice 1 162 consists of logical block 1 through logical block k (where k is the number of logical blocks in each slice), slice 2 164 consists of logical block k+1 through logical block 2k, and so on through slice M 174, which consists of logical block (x−k)+1 through logical block x.

The storage object logic 160 uses individual slices of LUN 161 and LUN 176 to access the non-volatile storage that is to be used to store host data when processing write I/O operations within host I/O operations 112, and from which host data is to be read when processing read I/O operations within host I/O operations 112. For example, non-volatile storage may be accessed through specific slices of LUN 161 and/or LUN 176 in order to support one or more storage objects (e.g. other logical disks, file systems, etc.) that are exposed to hosts 110 by data storage system 116. Alternatively, slices within LUN 161 and/or LUN 176 may be exposed directly to write I/O operations and/or read I/O operations contained within host I/O operations 112.

For each one of LUNs 161 and 176, all host data that is directed to each individual slice in the LUN is completely stored in the drive extents that are indicated by the RAID extent entries contained in a rotation group to which the slice is mapped according to a mapping between the slices in the LUN and the rotation groups in the RAID extent group corresponding to the LUN. For example, mapping 158 maps each slice in LUN 161 to a rotation group in RAID extent group 1 146. Accordingly, all host data in write I/O operations directed to a specific slice in LUN 161 is completely stored in drive extents that are indicated by the RAID extent entries contained in a rotation group in RAID extent group 1 146 to which that slice is mapped according to mapping 158.

Mapping 178 maps each slice in LUN 176 to a rotation group in RAID extent group 2 148. Accordingly, all host data in write I/O operations directed to a specific slice in LUN 176 is completely stored in drive extents that are indicated by the RAID extent entries contained in a rotation group in RAID extent group 2 148 to which that slice is mapped according to mapping 178.

In some embodiments, multiple slices may be mapped to individual rotation groups, and the host data directed to all slices that are mapped to an individual rotation group is stored on drive extents that are indicated by the RAID extent entries contained in that rotation group.

In some embodiments, storing host data in write I/O operations directed to a specific slice into the drive extents that are indicated by the RAID extent entries contained in the rotation group to which that slice is mapped may include striping portions (e.g. blocks) of the host data written to the slice across the drive extents indicated by one or more of the RAID extent entries contained in the rotation group, e.g. across the drive extents indicated by one or more of the RAID extent entries contained in the rotation group that are used to store data. Accordingly, for example, in a 4D+1P RAID-5 configuration, the disclosed technology may operate by segmenting the host data directed to a given slice into sequential blocks, and storing consecutive blocks of the slice onto different ones of the drive extents used to store data that are indicated by one or more of the RAID extent entries contained in the rotation group to which the slice is mapped.

The size of each LUN generated by storage object logic 160 is a sum of the capacities of the drive extents that are indicated by the RAID extent entries in the corresponding RAID extent group that are used to persistently store host data that is directed to the slices contained in the LUN. For example, the size of LUN 161 is a sum of the capacities of the drive extents that are indicated by the RAID extent entries in RAID extent group 1 146 and that are used to store host data that is directed to the slices contained in LUN 161.

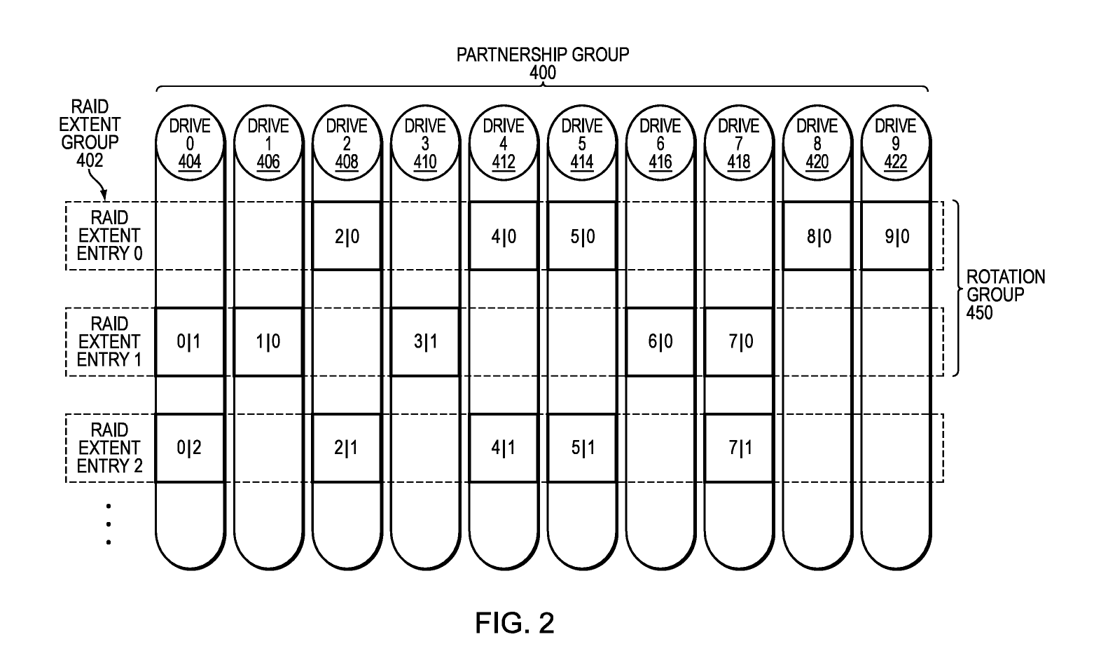

FIG. 2 is a block diagram showing an example of a partnership group of data storage drives 400, a RAID extent group 402 of RAID extent entries, and an example of a rotation group 450 of RAID extent entries contained within the RAID extent group 402. As shown in FIG. 2, each RAID extent entry indicates five drive extents, and the total number of data storage drives in partnership group 400 is ten. Accordingly, the number of RAID extent entries in each rotation group in RAID extent group 402 is two, as is shown by rotation group 450, which includes RAID extent entry 0 and RAID extent entry 1. Also in the example of FIG. 2, the set of drive extents indicated by each rotation group in RAID extent group 402 indicates one and only one drive extent from each one of the data storage drives in partnership group 400, as is also shown by rotation group 450, which indicates one drive extent located on each one of the data storage drives in partnership group 400.

While for purposes of concise illustration only one rotation group (i.e., rotation group 450) is shown in FIG. 2, that contains RAID extent entry 0 and RAID extent entry 1, RAID extent group 402 includes multiple rotation groups made up of other sets of two RAID extent entries contained in RAID extent group 402. Moreover, while for purposes of concise illustration only the three initial RAID extent entries are shown in RAID extent group 402, e.g. RAID extent entry 0, RAID extent entry 1, and RAID extent entry 2, RAID extent group 402 includes some number of other RAID extent entries up to some total number of RAID extent entries that are contained in RAID extent group 402. Accordingly, RAID extent group 402 includes a first RAID extent entry 0, a second RAID extent entry 1, a third RAID extent entry 2, and so on for some total number of RAID extents in RAID extent group 402.

The RAID extent group 402 may be contained in a RAID extent table in embodiments or configurations that provide mapped 4D+1P RAID-5 striping and data protection. Accordingly, within each RAID extent entry in RAID extent group 402, four of the five indicated drive extents are used to store host data, and one of the five indicated drive extents is used to store parity information.

RAID extent entry 0 is shown for purposes of illustration indicating a first drive extent 2|0, which is the first drive extent in data storage drive 2 408, a second drive extent 4|0, which is the first drive extent in data storage drive 4 412, a third drive extent 5|0, which is the first drive extent in data storage drive 5 414, a fourth drive extent 8|0, which is the first drive extent in data storage drive 8 420, and a fifth drive extent 9|0, which is the first drive extent in data storage drive 9 422.

RAID extent entry 1 is shown for purposes of illustration indicating a first drive extent 0|1, which is the second drive extent in data storage drive 0 404, a second drive extent 1|0, which is the first drive extent in data storage drive 1 406, a third drive extent 3|1, which is the second drive extent in data storage drive 3 410, a fourth drive extent 6|0, which is the first drive extent in data storage drive 6 416, and a fifth drive extent 7|0, which is the first drive extent in data storage drive 7 418.

RAID extent entry 2 is shown for purposes of illustration indicating a first drive extent 0|2, which is the third drive extent in data storage drive 0 404, a second drive extent 2|1, which is the second drive extent in data storage drive 2 408, a third drive extent 4|1, which is the second drive extent in data storage drive 4 412, a fourth drive extent 5|1, which is the second drive extent in data storage drive 5 414, and a fifth drive extent 7|1, which is the second drive extent in data storage drive 7 418.

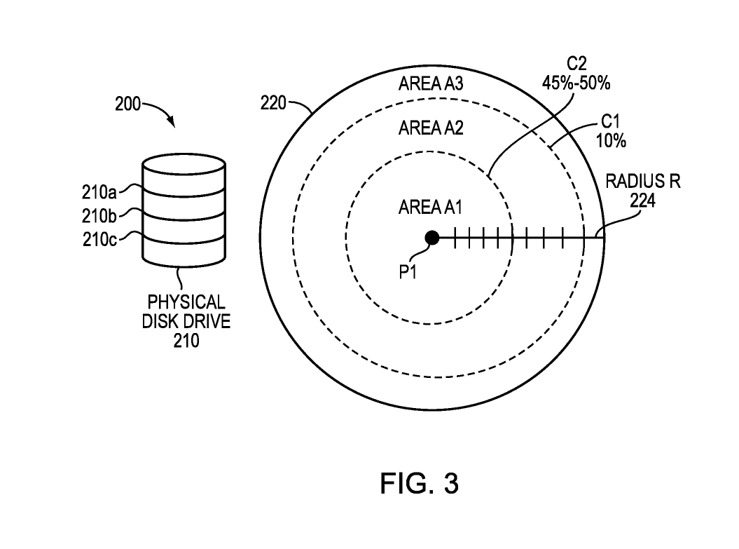

Referring to FIG. 3, shown is an example of a data storage drive as may be used in an embodiment in accordance with techniques herein. The example 200 includes a physical disk drive 210 that is a rotating disk drive. A disk drive may comprise several platters 210a-c and data may be read from/written to on one or two surfaces/sides of a platter using a device head (e.g., 4 platters may have 8 heads, each head being associated with a particular platter and surface thereof). Tracks may form concentric circles on a single platter surface. A cylinder may be defined to include the same track number on each platter spanning all such tracks across all platters of the device. Thus, a particular platter and surface thereof may denote a vertical position and the track or cylinder may denote a horizontal position or location on a surface.

Element 220 is a representation of a surface of a single platter which may include concentric tracks. The surface 220 is illustrated as including a radius R 224, circumferences or circles denoted C1 and C2, and areas A1, A2 and A3. The radius R 224 may denote the radius of the surface. Area A3 corresponds to a physical portion of the surface including tracks located between the circumference or circle C1 and the outer edge of the surface of 220. Area A1 corresponds to a physical portion of the surface include tracks located between the circumference or circle C2 and the center point P1 of the surface 220. Area A1 represents the innermost tracks or portion of the surface. Area A3 represents the outermost tracks or portion of the surface. Area A2 corresponds to a physical portion of the surface remaining (e.g., other than areas A1 and A3) as defined by the boundaries denoted by C1 and C2. Therefore, the entire physical surface capable of storing data may be partitioned into the three areas A1, A2 and A3. In this example, the radius R 224 may be divided into 10 segments as illustrated so that each segment corresponds to approximately 10% of the radius R 224 of the surface 220.

As discussed above, and as will be discussed further below, the techniques described herein form RAID extents from drive extents associated with corresponding areas of different data storage drives. It should be understood that cylinders of the data storage drive 210 may be split into a number of continuous ranges such that the cylinders in a range have similar I/O characteristics. For example, the areas A1, A2 and A3 may be associated with cylinders having similar I/O characteristics. The I/O performance of a HDD depends on which cylinders is measured. For example, the outer cylinders may provide 1.5× advantage over the inner ones. Thus, RAID extents from outer cylinders of drives will be able to fully utilize the I/O potential of the drives. It, therefore, makes sense to create RAID extents (and rotation and RAID groups) from drive extents situated on the same cylinders to have a uniform I/O rate. This approach, advantageously, facilitates effective utilization of the different I/O capabilities for different cylinder ranges.

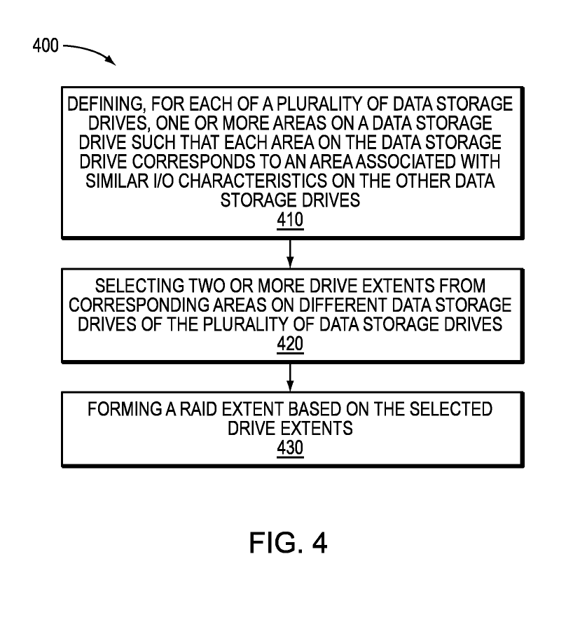

FIG. 4 shows an example method 400 that may be carried out in connection with the system 116. The method 400 typically performed, for example, by the software constructs described in connection with FIG. 1, which reside in the memory 126 of the storage processor 120 and are run by the processing circuitry 124. The various acts of method 400 may be ordered in any suitable way. Accordingly, embodiments may be constructed in which acts are performed in orders different from that illustrated, which may include performing some acts simultaneously.

At step 410, the method comprises defining, for each of a plurality of data storage drives, one or more areas on a data storage drive such that each area on the data storage drive corresponds to an area associated with similar I/O characteristics on the other data storage drives. At step 420, the method comprises selecting two or more drive extents from corresponding areas on different data storage drives of the plurality of data storage drives. At step 430, the method comprises forming a RAID extent based on the selected drive extents.

In at least one embodiment, the method as described herein may also consist of the following features:
1. HDD RAID groups creation aware of cylinder range:
   a. Split HDD cylinders into a number of continuous ranges, where cylinders in a range have similar I/O characteristics.
      i. The number of ranges can vary. For example, it can be two ranges (e.g., high and low), three ranges (e.g., high, medium and low), etc.
   b. Create RAID extents using drive extents (DE's) from the same range.
   c. Create rotation groups using RAID extents from the same range.
   d. Create RAID groups from rotation groups of the same range as well.
2. HDD RAID group creation aware of the used HDDs inside the same range:
   a. The size of the rotation group can be less than the number of drives in the partnership group (or DPG). For example, the number of drives can be 9 and the rotation group size is 5 for 4+1 RAID.
   b. Create a number of RAID groups inside the same range of cylinders, where the intersection of used HDD is minimal between RAID groups and allows one to place not related objects to the different physical drives and therefore improve the performance.

As mentioned above, suppose in an example the number of drives is 9 and the rotation group size is 5 for 4+1 RAID. In such a scenario, the first RAID group may be created from RAID extents using the first 5 drives mostly (1^{st}-5^{th} drives namely) and the second RAID group from RAID extents using the last 5 drives mostly (5^{th}-9^{th}) such that the RAID groups may be located on almost separate sets of drives (with minimal intersection). It means that I/O directed to the first RAID group may not be impacted (or impacted very little) by the I/O directed to the second RAID group which makes them suitable to independent storage object.
3. Partnership groups (or DPG's), RAID groups and HDD performance accounting and I/O balancing:
   a. DPG performance is defined by the max number of IOPS that can be obtained from its HDD's.
   b. RAID group performance is defined by the number of IOPS, which can be obtained accessing its range of cylinders and, therefore, varies from range to range.
   c. A performance consumption policy requires that a RAID group, its DPG, and the HDDs (from which DEs are used) have performance “capacity” for an object (slice) with certain performance requirements:
      i. HDD accounting is required because the size of rotation group (where a slice is placed) can be less than total number of drives in the DPG. For example, the DPG can have 14 HDD's, and as a result the size of a rotation group for 4+1 RAID will be 10. The slice I/O will, therefore, go to 10 drives from 14.
   d. Once a slice is put on a RAID Group, its performance requirements are subtracted from: the RAID group, its DPG and the HDDs.

For example, suppose the following situation: 3 drives in a partnership group, 1+1 RAID and two RAID groups. The first RAID group consumes high performance range and the second RAID group is situated on the lower performance range. The performance of each drive is 150. Thus, the performance of the partnership group is 450, whereas performances of the respective groups are 450 and 300. If a slice requiring 200 IOPS is put on the first RAID group then the IOPS are consumed from that particular group and the corresponding partnership group and drives (two as rotation group is situated on two drives). After consumption, the DPG will have 250 IOPS (e.g., 50, 50, and 150 IOPS assuming the slice is situated on the first two drives) and the first RAID group will have 250. However, it will not be possible to put another slice requiring 200 IOPS on it. Even if that RAID group has the capacity (it is 250 IOPS now and the partnership group has its 250 IOPS to be consumed) there are no two drives able to handle 100 IOPS each assuming that the slice's I/O is evenly distributed between drives it is situated on.
4. Slice to RAID group placement aware of their locality:
   a. Once a RAID group is situated on a number of consequent cylinders, the subsequent accesses to them can be performed more efficiently as it requires the minimal movement of the HDD “heads”.
   b. Placing the related objects (slices) into the same RAID group will, therefore, increase the throughput of the array. As the related objects are accessed together, then their close location will improve the processing of the I/O.
   c. The system places the related slices to the same/close RAID group if possible, the relation can be detected by:
      i. slices belong to the same logical object (LUN, FS)
      ii. slices belong to the same logical object and are close to each other (in its address space)
      iii. slices allocated at the same (or close) time
      iv. slices belongs to the related logical objects (for example, snapshots of the same FS and the FS)

It should be understood that there are dependencies between I/O accesses as the data belonging to the same object accessed by the same application will most like be accessed together. If they are situated close, the accesses can be optimized. For example, if the data accessed together are situated on the adjacent cylinders they can be fetched more easily and HDD controller may be able to optimize the head movement. The rotation groups are mapped to HDD cylinders so it is possible to put the related slices physically close to each other by placing them to the corresponding rotation groups.
5. Placing not related slices to the different physical drives:
   a. The system can decide that some slices are not related if they:
      i. belong to different LUNs, FS
      ii. created at different times
      iii. have a different type
      iv. are not detected as “related” ones
   b. The not related slices can be put to different DPGs.
   c. The not related slices can be put to different RAID groups, where these RAID groups are using different drives mostly.
   d. This allows the parallel access to the not related objects, which are mostly used by the different applications or users.
   e. This decrease the influence from the not related parallel activities to each other.

For example, in one embodiment, suppose a 3-drive-DPG and 1+1 RAID scenario, a slice is situated on two drives as a rotation group includes a single RAID extent consisting from two DEs. If slice 1 is situated on drives A and B and slice 2 is not related to it, then it would make sense to put it into rotation group, which is situated on drives A and C or B and C as it will enable some level of parallel access to them at least.
6. Slice to RAID group in a certain range placement aware of their I/O characteristics:
   a. The system identifies if a slice should be put on the highest or lowest range of cylinders. It can be done using the following criteria:
      i. the slice belongs to the LUN with a corresponding tiering policy (highest available, lowest available)
      ii. the slice has the type, which dictates the range, for example, metadata are placed on the highest range
   b. The system calculates the I/O temperature (based on I/O statistics) for slices and places them in the order of the temperature decrease to the highest range (hottest first) and in the order of the temperature increase to the lowest range.
   c. The system distributes the slices between all the RAID groups belonging to the same range in HDD tier starting from the highest one.
      i. so the most I/O consuming slices are distributed evenly between the most I/O capable range in all the HDDs
      ii. and the rest of slices are distributed between drives in accordance with their I/O nature, temperature and available resources

The issue here is which range to use to place a slice on, the more capable or less capable. The idea is that I/O temperature is used and the slice is put to the more capable range starting from the hottest one. If the slices relate to archive content then it makes sense to put them into less capable ranges starting from one with lowest temperature.

As will be appreciated by one skilled in the art, aspects of the technologies disclosed herein may be embodied as a system, apparatus, method or computer program product.

Accordingly, each specific aspect of the present disclosure may be embodied using hardware, software (including firmware, resident software, micro-code, etc.) or a combination of software and hardware. Furthermore, aspects of the technologies disclosed herein may take the form of a computer program product embodied in one or more non-transitory computer readable storage medium(s) having computer readable program code stored thereon for causing a processor and/or computer system to carry out those aspects of the present disclosure.

Any combination of one or more computer readable storage medium(s) may be utilized. The computer readable storage medium may be, for example, without limitation, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any non-transitory tangible medium that can contain, or store a program for use by or in connection with an instruction execution system, apparatus, or device.

The figures include block diagram and flowchart illustrations of methods, apparatus(s) and computer program products according to one or more embodiments of the invention. It will be understood that each block in such figures, and combinations of these blocks, can be implemented by computer program instructions. These computer program instructions may be executed on processing circuitry to form specialized hardware. These computer program instructions may further be loaded onto a computer or other programmable data processing apparatus to produce a machine, such that the instructions which execute on the computer or other programmable data processing apparatus create means for implementing the functions specified in the block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block or blocks.

Those skilled in the art should also readily appreciate that programs defining the functions of the present invention can be delivered to a computer in many forms, including without limitation: (a) information permanently stored on non-writable storage media (e.g. read only memory devices within a computer such as ROM or CD-ROM disks readable by a computer I/O attachment); or (b) information alterably stored on writable storage media (e.g. floppy disks and hard drives).

While the invention is described through the above exemplary embodiments, it will be understood by those of ordinary skill in the art that modification to and variation of the illustrated embodiments may be made without departing from the inventive concepts herein disclosed.

1. A method, comprising:
defining, for each of a plurality of data storage drives, one or more areas on a data storage drive such that each area on the data storage drive corresponds to an area associated with similar I/O (Input/Output) characteristics on the other data storage drives, wherein the data storage drive comprises a disk drive, and wherein defining the one or more areas on the data storage drive comprises organizing cylinders associated with the disk drive into one or more continuous ranges such that cylinders in a range have similar I/O characteristics;
selecting two or more drive extents from corresponding areas on different data storage drives of the plurality of data storage drives; and
forming a RAID (redundant array of independent disks) extent based on the selected drive extents.

2. (canceled)

3. The method as claimed in claim 1, wherein the one or more areas are defined on the data storage drive based on their respective physical positions on the data storage drive.

4. The method as claimed in claim 3, wherein the one or more areas are defined on the data storage drive based on their closeness to one of an outer edge of the data storage drive or a center of the data storage drive.

5. The method as claimed in claim 1, wherein the method further comprises creating a rotation group based on the RAID extent formed by drive extents from the corresponding areas on the different storage drives.

6. The method as claimed in claim 5, wherein the method further comprises creating a RAID group based on the rotation group.

7. An apparatus, comprising:
memory; and
processing circuitry coupled to the memory, the memory storing instructions which, when executed by the processing circuitry, cause the processing circuitry to:
define, for each of a plurality of data storage drives, one or more areas on a data storage drive such that each area on the data storage drive corresponds to an area associated with similar I/O (Input/Output) characteristics on the other data storage drives, wherein the data storage drive comprises a disk drive, and wherein defining the one or more areas on the data storage drive comprises organizing cylinders associated with the disk drive into one or more continuous ranges such that cylinders in a range have similar I/O characteristics;
select two or more drive extents from corresponding areas on different data storage drives of the plurality of data storage drives; and
form a RAID (redundant array of independent disks) extent based on the selected drive extents.

8. (canceled)

9. The apparatus as claimed in claim 7, wherein the one or more areas are defined on the data storage drive based on their respective physical positions on the data storage drive.

10. The apparatus as claimed in claim 9, wherein the one or more areas are defined on the data storage drive based on their closeness to one of an outer edge of the data storage drive or a center of the data storage drive.

11. The apparatus as claimed in claim 7, wherein the memory stores instructions which, when executed by the processing circuitry, cause the processing circuitry to create a rotation group based on the RAID extent formed by drive extents from the corresponding areas on the different storage drives.

12. The apparatus as claimed in claim 11, wherein the memory stores instructions which, when executed by the processing circuitry, cause the processing circuitry to create a RAID group based on the rotation group.

13. A computer program product having a non-transitory computer readable medium which stores a set of instructions, the set of instructions, when carried out by processing circuitry, causing the processing circuitry to perform a method of:
defining, for each of a plurality of data storage drives, one or more areas on a data storage drive such that each area on the data storage drive corresponds to an area associated with similar I/O (Input/Output) characteristics on the other data storage drives, wherein the data storage drive comprises a disk drive, and wherein defining the one or more areas on the data storage drive comprises organizing cylinders associated with the disk drive into one or more continuous ranges such that cylinders in a range have similar I/O characteristics;
selecting two or more drive extents from corresponding areas on different data storage drives of the plurality of data storage drives; and
forming a RAID (redundant array of independent disks) extent based on the selected drive extents.

14. (canceled)

15. The computer program product as claimed in claim 13, wherein the one or more areas are defined on the data storage drive based on their respective positions on the data storage drive.

16. The computer program product as claimed in claim 15, wherein the one or more areas are defined on the data storage drive based on their respective physical positions on the data storage drive.

17. The computer program product as claimed in claim 13, wherein the method further comprises creating a rotation group based on the RAID extent formed by drive extents from the corresponding areas on the different storage drives.

18. The computer program product as claimed in claim 17, wherein the method further comprises creating a RAID group based on the rotation group.
